(19) United States
(12) Patent Application Publication
(10) Pub. No.: US 2024/0391595 A1
(43) Pub. Date: Nov. 28, 2024

(54) SEAT BELT WEB RETRACTORS AND ASSOCIATED SYSTEMS AND METHODS

(71) Applicant: AmSafe, Inc., Phoenix, AZ (US)

(72) Inventors: Kenneth Heck, El Mirage, AZ (US); Christopher Arnold, Phoenix, AZ (US); Todd Humbert, Chandler, AZ (US)

(21) Appl. No.: 18/674,344

(22) Filed: May 24, 2024

Related U.S. Application Data
(60) Provisional application No. 63/504,678, filed on May 26, 2023.

(51) Int. Cl. B64D 25/06

(52) U.S. Cl. CPC B64D 25/06

(57) ABSTRACT

Seat belt web retractors having web locking mechanisms are described herein. In some embodiments, a seat belt web retractor includes an inertial locking mechanism operably coupled to a spool about which a seat belt web is wound. The web retractor further includes a web locking mechanism operably coupled to the inertial locking mechanism. The web locking mechanism can include a driving member that is actuated by engagement of the inertial locking mechanism with the web spool in response to rapid extraction of the web from the retractor. Actuation of the driving member drives first and second clamping portions toward each other, thereby clamping the web in between the clamping members and restraining the web from further movement out of the retractor.

### CROSS-REFERENCE TO RELATED APPLICATION(S)

The present application claims the benefit of U.S. Provisional Application No. 63/504,678, filed May 26, 2023, the disclosure of which is incorporated herein by reference in its entirety.

### TECHNICAL FIELD

The present disclosure is generally related to seat belt web retractors, and more particularly, to seat belt web retractors for use with occupant restraint systems in aircraft.

### BACKGROUND

Seat belt restraint systems in aircraft, automobiles, and other vehicles often include a web retractor operably coupled to one end of a seat belt web (which can also be referred to as seat belt “webbing”). The retractor typically includes a spring-loaded spool onto which the web is wound. During normal vehicle operation, the retractor pays out the web from the spool and retracts the web onto the spool as necessary to accommodate normal movement of the occupant in their seat. However, if the web is pulled rapidly from the retractor by movement of the seat occupant's body in response to, for example, a crash or other dynamic event above a preset threshold, the retractor locks the spool to prevent further payout of the web and restrain the occupant in their seat.

One problem associated with conventional seat belt retractors results from a condition known as web film spooling or web spooling. When the retractor spool locks during a dynamic event, the web wound onto the spool compresses, thereby allowing an additional portion of the web to pay out from the spool before the web carries the full load and prevents further excursion of the seat occupant. On seat belt systems having a substantial length of web wound onto the retractor spool, web film spooling can result in multiple inches of additional web paying out from the retractor after the retractor spool locks. This additional payout of web is generally undesirable because it allows additional excursion (e.g., forward excursion) of the occupant's body and potential contact with strike hazards during a crash or other significant dynamic event.

Many first class and business class seats on commercial airlines that convert into lay-flat beds are required to have three-point seat belt restraints that restrain the seat occupant in both upright and lay-flat configurations. Depending on the restraint configuration, this requirement can result in a shoulder belt length that is significantly longer than would otherwise be required for a seat that does not convert into a lay-flat bed. In some instances, the increased shoulder belt length can make federal certification of these restraint systems difficult under dynamic conditions because of the increased occupant excursion resulting from the additional web film spooling caused by the increased belt length. Accordingly, it would be advantageous to provide a web retractor for use with such seating configurations that reduces the payout of additional web as a result of film spooling.

### BRIEF DESCRIPTION OF THE DRAWINGS

FIGS. 1A and 1B are front-side and rear-side isometric views, respectively, of a seat with a seat belt restraint system having a seat belt web retractor configured in accordance with embodiments of the present technology.

FIGS. 1C and 1D are partially schematic side views of a vehicle occupant secured in a seat by a seat belt restraint system having a seat belt web retractor configured in accordance with other embodiments of the present technology.

FIGS. 2A and 2B are right- and left-side isometric views, respectively, of a seat belt web retractor configured in accordance with embodiments of the present technology.

FIGS. 3A and 3B are partially exploded right- and left-side isometric views, respectively, of the seat belt web retractor of FIGS. 2A and 2B illustrating an inertial locking mechanism configured in accordance with embodiments of the present technology, and FIG. 3C is an enlarged isometric view of a locking pawl and a pawl arm of the inertial locking mechanism.

FIG. 4A is a partially exploded right-side isometric view of the seat belt web retractor of FIGS. 2A and 2B illustrating a web locking mechanism configured in accordance with embodiments of the present technology.

FIG. 4B is a right-side view of the seat belt web retractor of FIGS. 2A and 2B with certain components removed for purposes of illustration and with the web retractor in an unlocked configuration in accordance with embodiments of the present technology.

FIG. 4C is an enlarged right-side view of a portion of the web locking mechanism of FIG. 4A with certain components removed for purposes of illustration and with the web retractor in an unlocked configuration in accordance with embodiments of the present technology.

FIG. 4D is a right-side view of the seat belt web retractor of FIGS. 2A and 2B and is similar to FIG. 4B but with the web retractor in a locked configuration in accordance with embodiments of the present technology.

FIG. 4E is an enlarged right-side view of a portion of the web locking mechanism of FIG. 4A and is similar to FIG. 4C but with the web retractor in a locked configuration in accordance with embodiments of the present technology.

### DETAILED DESCRIPTION

The following disclosure describes various embodiments of seat belt web retractors that include one or more clamping members that lock the web in response to the web being pulled from the retractor at a rate that exceeds a preset limit. For example, in some embodiments the web retractors described herein include an inertial locking mechanism that is operably coupled to a web spool. When the web is pulled rapidly from the spool, the rotational acceleration of the spool causes the inertial locking mechanism to engage the spool with a web locking mechanism and drive a pair of clamping members toward each other, thereby clamping the web therebetween and preventing further pay out of the web from the retractor as a result of web spooling. Since the clamping members are mounted to the retractor frame, the load from the seat occupant during a crash or other dynamic event is transmitted directly from the portion of shoulder web extending around the occupant, through the retractor frame, and into the retractor mounting structure. This removes the length of seat belt web that is wound about the retractor spool from the load path, and as a result there is little or no web spooling to allow additional web to pay out from the retractor during the dynamic event.

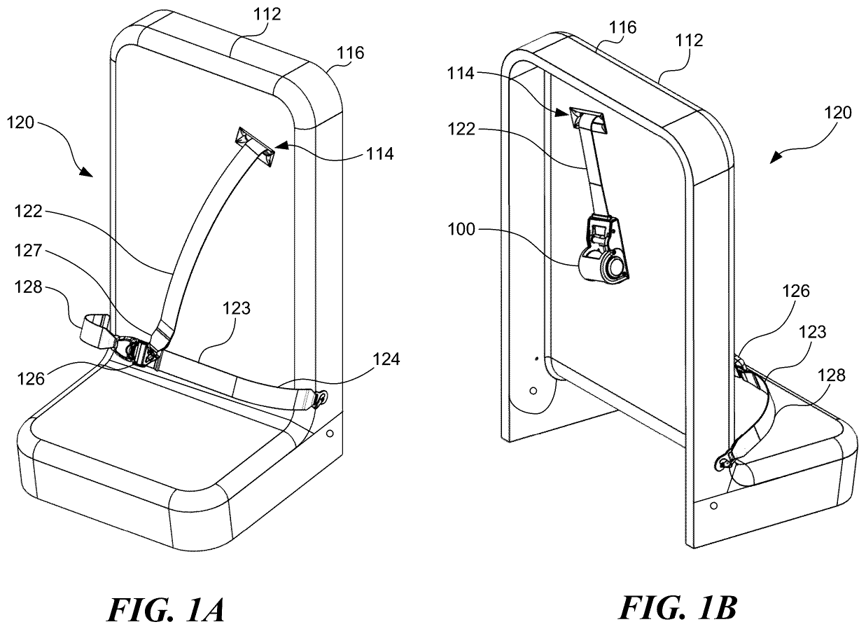

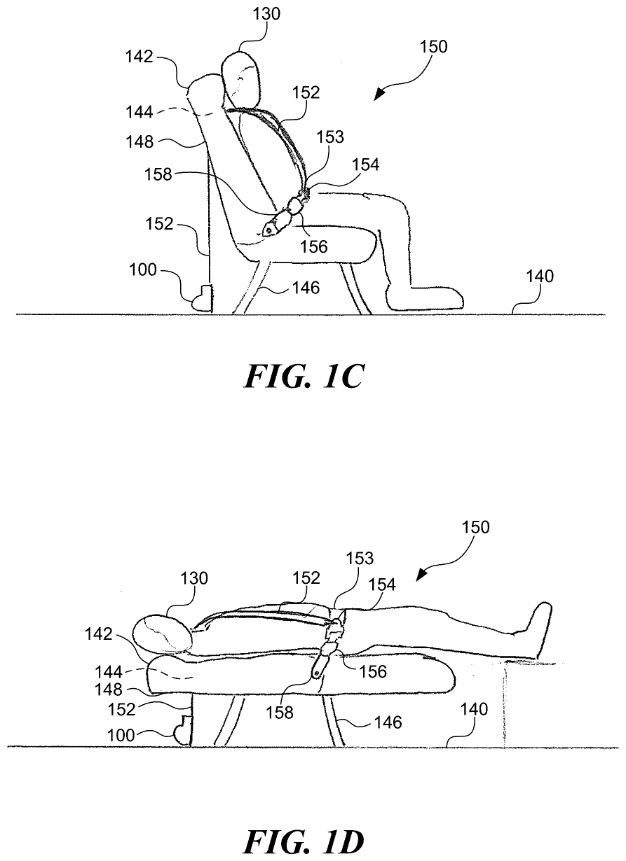

Certain details are set forth in the following description and in FIGS. 1A-4E to provide a thorough understanding of various embodiments of the present technology. In other instances, well-known structures, materials, operations and/or systems often associated with seat belt systems, web retractors, aircraft seats and seating arrangements, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying figures depict embodiments of the present technology and are not intended to be limiting of its scope. The sizes of various depicted elements are not necessarily drawn to scale, and these various elements may be arbitrarily enlarged to improve legibility. Component details may be abstracted in the figures to exclude details such as position of components and certain precise connections between such components when such details are unnecessary for a complete understanding of how to make and use the invention. Additionally, many of the details, dimensions, angles and other features shown in the figures may merely be illustrative of particular embodiments of the disclosure. Accordingly, other embodiments can have other details, dimensions, angles and features without departing from the spirit or scope of the present invention. Those of ordinary skill in the art will appreciate that further embodiments of the invention can be practiced without several of the details described below.

In the figures, identical reference numbers identify identical, or at least generally similar, elements. To facilitate the discussion of any particular element, the most significant digit or digits of any reference number refers to the FIG. in which that element is first introduced. For example, element 112 is first introduced and discussed with reference to FIG. 1A.

FIGS. 1A and 1B are front-side and rear-side isometric views, respectively, of a seat 112 having a personal restraint system 120 with a seat belt web retractor 100 configured in accordance with embodiments of the present technology. The seat 112 can be reclinable or fixed in a generally upright configuration. Referring to FIGS. 1A and 1B together, in the illustrated embodiment, the personal restraint system 120 includes a shoulder belt 122 (which can also be referred to as a “seat belt web 122”) and a lap belt 123. The lap belt 123 includes a first web 124 and a second web 128. The first web 124 includes a first end portion fixedly attached to a seat frame 116 on the left side of the seat 112, and a second end portion that carries a belt connector tongue. The second web 128 includes a first end portion fixedly attached to the right side of the seat frame 116, and a second end portion that carries a belt buckle 126 configured to releasably engage the connector tongue to secure the lap belt 123 in a conventional manner.

The shoulder belt 122 includes a web having a first end portion operably coupled to the web retractor 100 and a second end portion that carries a connector 127 for attaching the shoulder belt 122 to the lap belt 123 proximate the connector tongue. In some embodiments, the connector 127 can be configured to releasably attach the shoulder belt 122 to the lap belt 123 so that the shoulder belt 122 can be disconnected from the lap belt 123 at times when it is not required. In other embodiments, the connector 127 can form a permanent attachment of the shoulder belt 122 to the lap belt 123. In the illustrated embodiment, the shoulder belt 122 extends through an opening 114 in the seat 112 and the seat frame 116, and then downwardly for attachment to the web retractor 100.

In the illustrated embodiment, the web retractor 100 is fixedly attached to a rear side of the seat frame 116 via, e.g., a suitable fastener (e.g., a bolt). In other embodiments, the retractor 100 can be attached to other locations on the seat 112 and/or on adjacent portions of the vehicle structure. For example, in some embodiments, the retractor 100 can be mounted directly to the base of the seat 112.

FIGS. 1C and 1D are side views of an aircraft passenger 130 secured in a seat 142 by a restraint system 150 having the web retractor 100 configured in accordance with another embodiment of the present technology. In FIG. 1C, the seat 142 is positioned in a generally upright configuration, and in FIG. 1D the seat 142 has been reclined into a lay-flat configuration. Referring first to FIG. 1C, in the illustrated embodiment, the restraint system 150 includes a shoulder belt 152 (which can also be referred to as a “shoulder web 152”) and a lap belt 153. The lap belt 153 includes a first web 154 and a second web 158. The first web 154 includes a first end portion fixedly attached to a seat frame 146 on the left side of the seat 142, and a second end portion that carries a belt connector tongue. The second web 158 includes a first end portion fixedly attached to the right side of the seat frame 146, and a second end portion that carries a belt buckle 156 configured to releasably engage the connector tongue to secure the lap belt 153 around the passenger 130 in a conventional manner.

The shoulder belt 152 includes a web having a first end portion operably coupled to the web retractor 100 and a second end portion that carries a connector for attaching the shoulder belt 152 to the lap belt 153 proximate the connector tongue. In some embodiments, the connector can be configured to releasably attach the shoulder belt 152 to the lap belt 153 so that the shoulder belt 152 can be disconnected from the lap belt 153 at times when it is not required. In other embodiments, the connector can form a permanent attachment of the shoulder belt 152 to the lap belt 153. In the illustrated embodiment, the shoulder belt 152 extends over a shoulder of the passenger 130, through an opening 144 in the seat back 148, and then downwardly for attachment to the web retractor 100.

In the illustrated embodiment, the web retractor 100 is fixedly attached to a floor 140 of the aircraft passenger cabin behind and/or below the seat 142 via, e.g., a suitable fastener (e.g., a bolt). In other embodiments, the retractor 100 can be attached to other locations on the seat 602 and/or on adjacent portions of the aircraft structure. For example, in some embodiments, the retractor 100 can be mounted directly to the base of the seat 142.

Turning next to FIG. 1D, the seat 142 has been moved into a lay-flat configuration by rotating the seat back 148 downwardly and sliding the entire seat 142 forward relative to the seat frame 146. As this view illustrates, when the seat 142 is moved into the lay-flat configuration, a substantial portion of the shoulder web 152 must be retracted into the web retractor 100 for the shoulder web 152 to remain sufficiently snug around the passenger 130. As discussed above, the use of conventional web retractors in such a situation can result in undesirable pay out of the web if the aircraft experiences an accident or other significant dynamic event that causes the passenger 130 to be thrown forward against the restraint system 150. For example, there can be substantial film spooling of the web 152 because all the webbing wound around the spool of the retractor must compress before the web 152 can carry the full tension load required to restrain the passenger 130. Additionally, there can be significant elongation of the web 152 when the tension load is applied because of the substantial length of the web 152 that is wound about the spool of the retractor 100. Both of these factors can lead to additional pay out of the web 152 from the retractor 100 before the passenger 130 is fully restrained in the seat 142, and this additional pay out can result in excessive excursion of the passenger 130 and the potential for passenger impact with a strike hazard.

Conversely, use of the web retractor 100 in such applications can significantly reduce undesirable web pay out, as will be described in further detail below. Accordingly, in some embodiments, web retractors configured in accordance with the present technology can be advantageously used with relatively long seat belt webs without excessive passenger excursion from web film spooling or elongation under load.

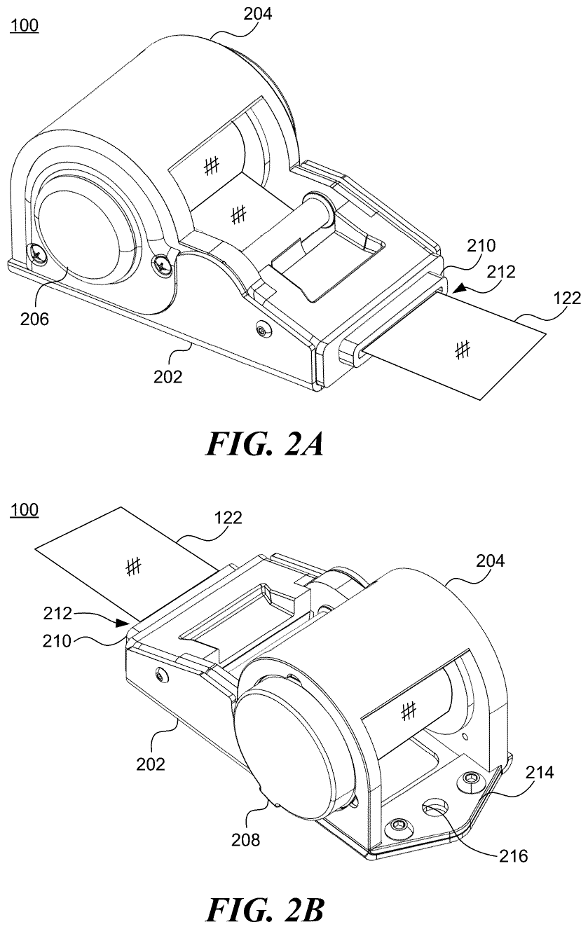

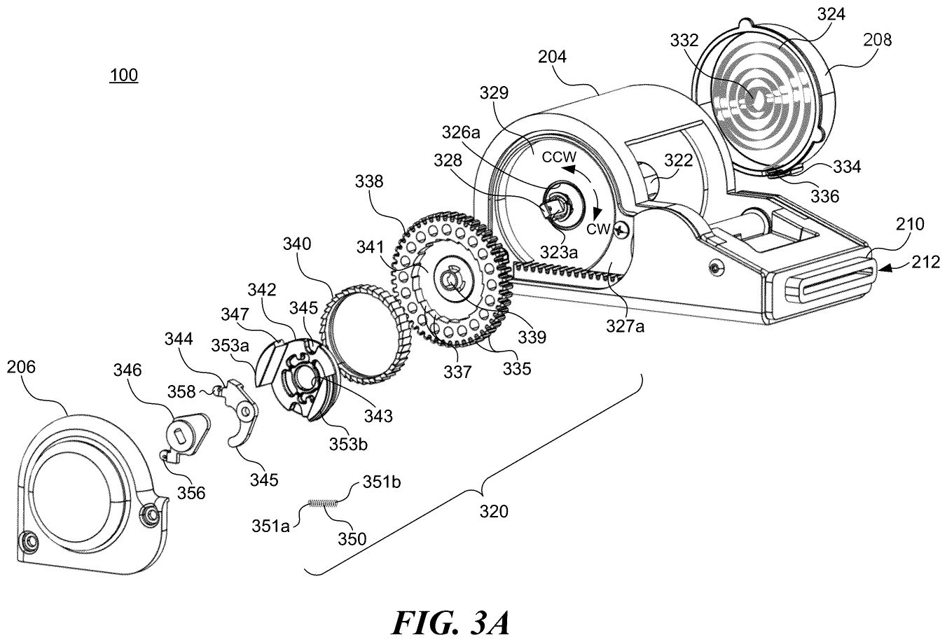

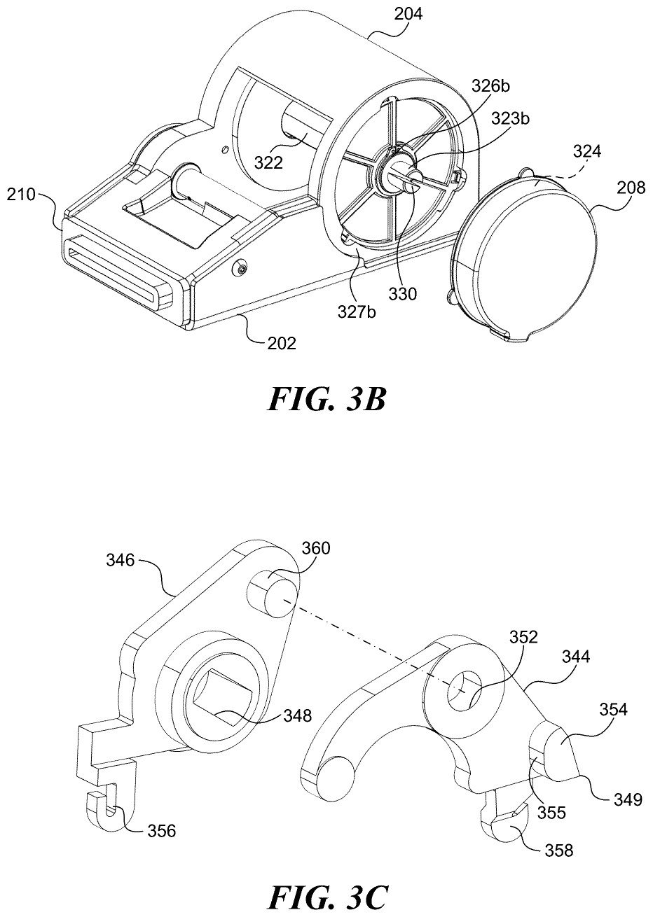

FIGS. 2A and 2B are right- and left-side isometric views, respectively, of the seat belt web retractor 100 configured in accordance with embodiments of the present technology. Referring to FIGS. 2A and 2B together, the web retractor 100 includes a spool housing 204 mounted to a retractor frame 202. As described in greater detail below with reference to FIG. 3A, the spool housing 204 encloses a spool shaft that is operably coupled at one end to an inertial locking mechanism contained under a right side cover 206, and at the other end to a torsion spring contained under a left side cover 208. As also described in greater detail below, a seat belt web 122 is wound about the spool shaft within the housing 204, and operably extends outwardly from the retractor 100 through a web aperture 212 in a web guide 210. As shown in FIG. 2B, the rear portions of the frame 202 and the housing 204 each includes a corresponding flange 214 having an opening 216 configured to receive a bolt or other fastening element to secure the web retractor 100 to a seat frame (as shown in, e.g., FIGS. 1A-1B), an aircraft structure (as shown in, e.g., FIGS. 1C-1D), or other mounting point in the aircraft or other vehicle in which the retractor 100 is used.

In some embodiments, the housing 204 can be formed from a molded plastic material of sufficient strength, and the frame 202 can be formed from a suitable metal, such as extruded aluminum. In other embodiments, the housing 204 and/or the frame 202 can be made from other suitable materials. For example, in some embodiments, the housing 204 can be formed from a suitable metal, such as aluminum, and/or the frame 202 can be made from metals other than aluminum, such as steel (e.g., stainless steel). During assembly, the frame 202 can be slid underneath the housing 204 and locked into place with one or more locking tabs, fasteners (e.g., screws), and/or other suitable attachment mechanisms. By way of example, the web 122 can be at least generally similar in structure and function to conventional seat belt webs formed from, for example, woven nylon webbing.

FIGS. 3A and 3B are partially exploded right- and left-side isometric views, respectively, of the seat belt web retractor 100 illustrating an inertial locking mechanism 320 configured in accordance with embodiments of the present technology, and FIG. 3C is an enlarged, partially exploded isometric view of a locking pawl 344 and a pawl arm 346 of the inertial locking mechanism 320. Referring first to FIGS. 3A and 3B, the web retractor 100 includes a spool shaft 322 having a first end portion 323a rotatably supported in a first opening 326a formed in a right side wall 327a of the housing 204, and an opposite second end portion 323b (FIG. 3B) rotatably supported in a second opening 326b formed in a left side wall 327b of the housing 204. The spool shaft 322 is configured to be fixedly attached to an end portion of the seat belt web 122 (FIG. 2A) via, e.g., a slot or other feature in a conventional manner. A torsion spring 324 (e.g., a spring steel torsion spring) is contained under the left side cover 208 and has an inner end portion 332 that is received in a slot 330 formed in the second end portion 323b of the spool shaft 322 to couple the torsion spring 324 to the spool shaft 322. The torsion spring 324 also includes an outer end portion 334 that is received in a slot 336 formed in the left side cover 208 to operably couple the torsion spring 324 to the left side cover 208. In operation, the torsion spring 324 is pre-wound in a counter-clockwise direction CCW before attachment to the spool shaft 322 to apply a biasing torsional force to the spool shaft 322 in a clockwise direction CW. This torsional force causes the spool shaft 322 to rotate in the clockwise direction CW and wind the seat belt web 122 (FIG. 2A) thereon to retract the web 122 when, for example, the web 122 is released or the associated seat belt is unbuckled by the seat occupant. This torsional force also removes slack in the web 122 when worn by the seat occupant, while at the same time allowing the spool shaft 322 to rotate in the counter-clockwise direction CCW to pay out the web 122 as necessary for the occupant to put on the seat belt.

In the illustrated embodiment, the inertial locking mechanism 320 includes a locking gear 338, a ring gear 340, and an inertia disk 342. The locking gear 338 includes a central opening 339 that enables the locking gear 338 to be rotatably mounted to the first end portion 323a of the spool shaft 322 within a recess 329 formed in the right side wall 327a of the housing 204. The locking gear 338 also includes a first plurality of teeth 335 extending around an outer periphery thereof, and a second plurality of teeth 337 extending around an inner periphery of a concentric recess 341. The inertia disk 342 includes opposing counterweight portions 353a, 353b, and a central opening 343 that enables the inertia disk 342 to be rotatably mounted to the first end portion 323a of the spool shaft 322 at least partially within the recess 341 formed in the locking gear 338. In some embodiments, the ring gear 340 can be fixedly attached to an outer perimeter 347 of the inertia disk 342 just outboard of the locking gear 338.

Referring next to FIG. 3C together with FIG. 3A, the pawl arm 346 includes a generally rectangular-shaped slot 348 and a cylindrical boss 360. The slot 348 is configured to fit tightly over a tang 328 on the first end portion 323a of the spool shaft 322 to key (and fix) the pawl arm 346 to the spool shaft 322. The cylindrical boss 360 extends into a corresponding cylindrical opening 352 in the locking pawl 344 to rotatably couple the locking pawl 344 to the pawl arm 346 between the pawl arm 346 and the inertia disk 342. Additionally, the locking pawl 344 also includes a boss 354 and a tooth or engagement surface 349. The boss 354 has a curved bearing surface 355 that is received in a corresponding recess 345 in the inertia disk 342. As described in greater detail below, the engagement surface 349 is configured to engage the teeth 337 on the inner periphery of the locking gear 338 when the web 122 (FIG. 1A) is withdrawn from the spool shaft 322 above a preset or threshold acceleration. The inertial locking mechanism 320 further includes a biasing member (e.g., a tension spring 350) having a first end portion 351a attached to a first hook portion 356 of the pawl arm 346, and a second end portion 351b attached to a second hook portion 358 of the locking pawl 344. The inertial locking mechanism 320 is one example of a suitable mechanism that can be used to engage the shaft 322 with the locking gear 338 when the web 122 is withdrawn from the retractor 100 above a preset acceleration. In other embodiments, other locking mechanisms can be used without departing from the present disclosure.

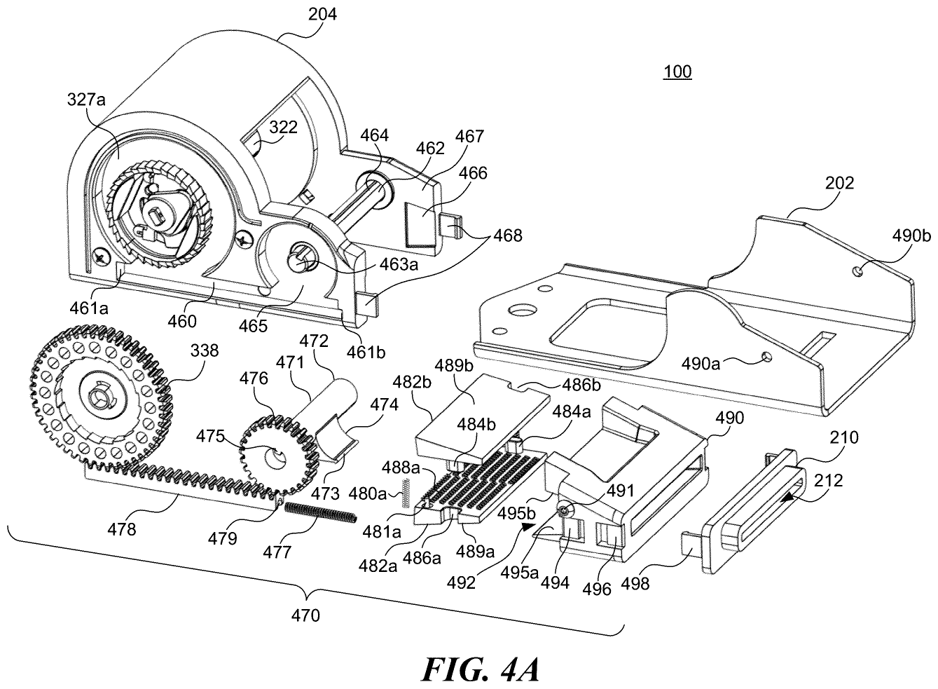

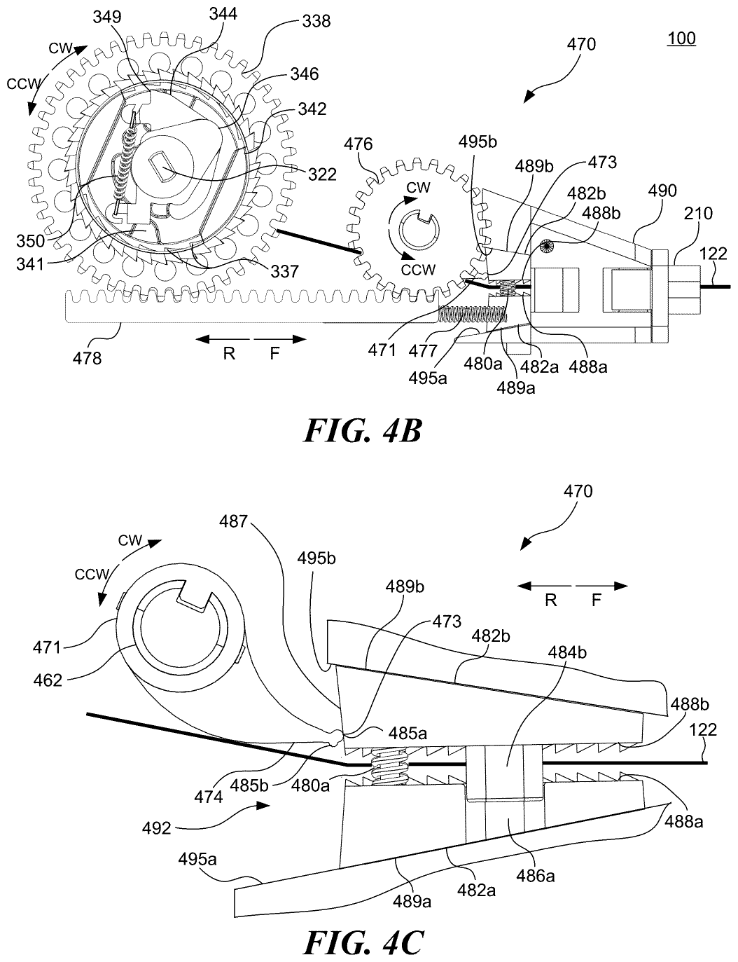

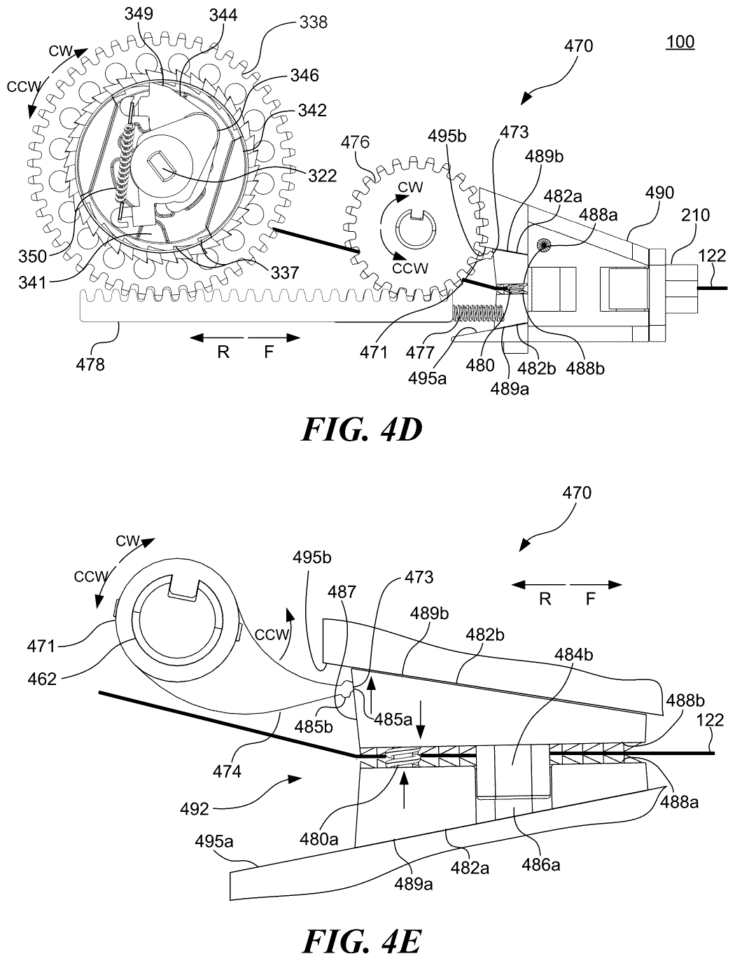

FIG. 4A is a partially exploded right-side isometric view of the seat belt web retractor 100 illustrating components of a web locking mechanism 470 configured in accordance with embodiments of the present technology. In the illustrated embodiment, the web locking mechanism 470 (which can also be referred to as a “web clamping mechanism 470”) includes a driving member 471 having a cam portion or head portion 474 and a collar portion 472. The collar portion 472 includes a longitudinal through hole configured to receive a shaft 462. The shaft 462 is spaced apart from the spool shaft 322 and is rotatably supported on opposite ends by opposing side walls of the housing 204. The shaft 462 includes an elongate longitudinal groove or keyway 464 configured to receive a correspondingly shaped elongate protrusion extending inwardly along the through hole in the collar portion 472 to fixedly attach the driving member 471 to the shaft 462 so that the driving member 471 rotates together with the shaft 462. A driven gear 476 is fixedly mounted to a first end portion 463a of the shaft 462 by means of a tab or protrusion 475 on the driven gear 476 that fits into the keyway 464 so that the shaft 462 rotates with the driven gear 476, which thereby rotates the driving member 471. The head portion 474 (which can also be referred to as a “cam portion 474”) of the driving member 471 (which can also be referred to as a “cam 471”) includes a bearing surface 473 on a distal edge portion thereof that is configured to interact with other components of the web locking mechanism 470, as described in further detail below.

In the illustrated embodiment, the web locking mechanism 470 further includes a gear rack 478 that is slidably received in an elongate recess 460 formed in the right side wall 327a and configured to slide back and forth between a first end portion 461a and a second end portion 461b of the elongate recess 460. The gear rack 478 includes a socket 479 at a forward end portion thereof that receives a corresponding end portion of a biasing member (e.g., a compression spring 477) whose opposite end portion is compressed against the second end portion 461b of the elongate recess 460. As described in greater detail below, the compression spring 477 biases the gear rack 478 toward the first end portion 461a of the elongate recess 460.

The web locking mechanism 470 further includes a first clamping member ca and a second clamping member 482b (the clamping members 482a, 482b can also be referred to as “clamping portions,” “clamping plates,” “jaws,” and the like). In the illustrated embodiment, the first and second clamping members 482a, 482b are physically identical, or at least substantially physically identical. Each clamping member 482a/b includes a protrusion 484a/b extending from one side thereof, a recess 486a/b on the other side thereof, and a boss 481a/b on each side thereof (only the boss 481a is visible in FIG. 4A). Each boss 481a/b is configured to extend into a corresponding end portion of a biasing member 480a/b (e.g., a compression spring), one of which is operably installed on each side of the clamping members 482a, 482b (only the biasing member 480a is visible in FIG. 4A). The biasing members 482a, 482b bias the clamping members 482a, 482b away from each other, and the bosses 481a, 481b retain the biasing members 482a, 482b in their respective positions between the clamping members 482a, 482b.

In addition to the foregoing, each of the clamping members 482a, 482b further includes a corresponding web contact or clamping surface 488a/b having a plurality of, e.g., ridges or teeth protruding therefrom (only the first clamping surface 488a is visible in FIG. 4A) to grip the seat belt web 122, and a bearing or sliding surface 489a/b that is oriented at a non-zero angle relative to the corresponding clamping surface 488a/b. In some embodiments, for example, the sliding surface 489a/b on each of the clamping members 482a/b can be positioned at an angle of from 2 degrees to 30 degrees, from 5 degrees to 20 degrees, from 5 degrees to 15 degrees, from 7 degrees to 12 degrees, or 10 degrees relative to the corresponding clamping surface 488a/b. When assembled, the first and second clamping members 482a, 482b are arranged vertically such that the clamping surfaces 488a, 488b face each other, the protrusion 484a/b of one clamping member 482a/b is slidably received in the recess 486a/b of the other clamping member 482a/b, and the biasing members 480 bias the first and second clamping members 482a, 482b away from each other.

The web locking mechanism 470 further includes a clamp housing 490 having a lower wall 495a and an upper wall 495b that are positioned at an angle relative to each other (i.e., non-parallel to each other) to define a tapered cavity a therebetween that slidably receives the first and second clamping members 482a, 482b. In some embodiments, for example, the angle between the lower and upper walls 495a, 495b can be from 4 degrees to 60 degrees, from 8 degrees to 40 degrees, from 10 degrees to 30 degrees, from 12 degrees to 24 degrees, or 20 degrees. As shown in FIGS. 4B-4E, in the illustrated embodiments the sliding surface 489a presses against and slidably contacts the lower wall 495a and the sliding surface 489b presses against and slidably contacts the upper wall 495b. The distance between the lower and upper walls 495a, 495b of the cavity 492 linearly decreases in direction F (FIG. 4C) so that, as described in greater detail below, the first and second clamping members 482a, 482b move toward each other to reduce the space between the clamping surfaces 488a, 488b as the first and second clamping members 482a, 482b are driven in direction F by the driving member 471.

When the web locking mechanism 470 is assembled, the driven gear 476 can be positioned inside a recess 465 of the housing 204 and fixedly engaged with the first end portion 463a of the shaft 462. The first and second clamping members 482a, 482b can be positioned at least partially in recesses 466 on the interior surfaces of the side walls 467 of the housing 204. The recesses 466 can include upper and lower edge portions shaped to slidably contact the sliding surfaces 489a, 489b of the first and second clamping members 482a, 482b. The clamp housing 490 can be fixedly attached to the spool housing 204 via tabs or other attachment features 468 of the spool housing 204 that fit into (e.g., snap into) corresponding recesses or other attachment features 494 of the clamp housing 490. Similarly, the web guide 210 can be fixedly attached to the front of the clamp housing 490 via tabs 498 on each side of the web guide 210 that engage corresponding recesses 496 on the sides of the clamp housing 490. The clamp housing 490 can be fixedly coupled to the frame 202 via fasteners 491 (e.g., screws) that threadably engage or otherwise fit into holes 490a, 490b in the opposing side walls of the frame 202.

By way of example, the various components of the web locking mechanism 470, such as the locking gear 338, the driving member 471, the driven gear 476, the gear rack 478, the clamp housing 490, and the first and second clamping members 492a, 482b, can be composed of one or more of the following: polyetherimide (e.g., PEI Ultem 1000 natural), polyoxymethylene (e.g., acetal delrin 570, 20% glass filled), polyetheretherketone (PEEK), acrylonitrile butadiene styrene (ABS), and/or alloy steel. In other embodiments, the various components of the web locking mechanism 470 can be composed of other suitable materials, such as other types of thermoplastics, metal, etc.

FIG. 4B is a right-side view of the web retractor 100 with the web locking mechanism 470 in an unlocked configuration in accordance with embodiments of the present technology. More specifically, FIG. 4B shows the web retractor 100 with the frame 202, the spool housing 204, the right side cover 206, and the left side cover 208 removed for the purpose of illustrating certain operational features of the web locking mechanism 470. FIG. 4C is an enlarged right-side view of a portion of the web locking mechanism 470 with the web locking mechanism 470 in the unlocked configuration and with additional components removed to better illustrate operation of the driving member 471 and the first and second clamping members 482a, 482b.

Referring to FIGS. 4B and 4C together, if a seat occupant pulls the seat belt web 122 outwardly from the retractor 100 in direction F, the movement of the web 122 will rotate the spool shaft 322 in the counterclockwise direction CCW. If the web 122 is withdrawn at a rate of acceleration that is below a preset level (e.g., below 1.5 g (i.e., below 48.25 ft/s²) and/or below a speed or acceleration corresponding to a potentially injurious accident or other rapid deceleration of the vehicle), the rotation of the spool shaft 322 in the counterclockwise direction CCW will drive the pawl arm 346 in the counterclockwise direction CCW, which in turn causes the locking pawl 344 to also rotate in the counterclockwise direction CCW by virtue of the tension in the spring 350, which pulls the locking pawl 344 inwardly toward the spool shaft 322 and the retracted position. As the locking pawl 344 rotates in this position, the boss 354 (FIG. 3C) bears against the side wall of the recess 345 (FIG. 3A) in the inertia disk 342, thereby also causing the inertia disk 342 to rotate in the counterclockwise direction CCW as the seat belt web 122 unwinds from the spool shaft 322. Because the locking pawl 344 is maintained in the retracted position by the spring 350, the engagement surface 349 rotates free of the teeth 337 on the inner surface of the recess 341 in the locking gear 338. As a result, the locking gear 338 remains stationary and the gear rack 478 also remains stationary in an aft position against the first end portion 461a of the elongate recess 460 (FIG. 4A). As shown in FIG. 4B, when the gear rack 478 is in this aft position, it positions the driven gear 476 such that the driving member 471 is in a lowered or retracted position. More specifically, as shown in FIG. 4C, when the driving member 471 is in the retracted position, a first rounded surface portion 485a of the bearing surface 473 contacts a lower portion of a bearing surface 487 on the aft end of the second clamping member 482b. In some embodiments, a second rounded surface portion 485b can also be provided below the first rounded surface portion 485a to provide a smooth surface against which the seat belt web 122 can slide if needed when the driving member 471 is in the retracted position.

The biasing members 480a, 480b bias the first and second clamping members 482a, 482b away from each other and toward the lower and upper walls 495a, 495b of the cavity 492 of the clamp housing 490, respectively. Because the lower and upper walls 495a, 495b are arranged at a non-zero angle relative to each other and the tapered cavity 492 tapers inwardly in direction F, the biasing members 480a, 480b also bias the first and second clamping members 482a, 482b aft in direction R and bias the bearing surface 487 of the second clamping member 482b against the bearing surface 473 of the driving member 471. When the driving member 471 is in the lower position and the clamping members 482a, 482b are in the aft, retracted position shown in FIG. 4C, the first and second clamping surfaces 488a, 488b are sufficiently spaced apart from each other such that the seat belt web 122 can be pulled freely from the retractor 100 in direction F, or conversely, retracted back into the retractor 100 and wound back onto the spool shaft 322 in direction R when the web 110 is released by virtue of the torsion spring 324 (FIG. 3A). Moreover, the web aperture 212 (FIG. 2A) in the web guide 210 can position the seat belt web 122 between (e.g., center the seat belt web 122 between) the opposing first and second clamping surfaces 488a, 488b so that the web 122 does not appreciably rub against either of the clamping surfaces 488a/b during extraction and retraction and potentially abrade on the teeth or ridges protruding therefrom.

FIG. 4D is a right-side view of the web retractor 100 with the web locking mechanism 470 in a locked configuration in accordance with embodiments of the present technology. Like FIG. 4B, FIG. 4D shows the web retractor 100 with the frame 202, the spool housing 204, the right side cover 206, and the left side cover 208 removed for the purpose of illustrating certain operational features of the web locking mechanism 470. FIG. 4E is an enlarged right-side view of a portion of the web locking mechanism 470 with the web locking mechanism 470 in the locked configuration and with additional components removed to better illustrate operation of the driving member 471 and the first and second clamping members 482a, 482b.

In FIGS. 4D and 4E, the seat belt web 122 has been momentarily pulled outwardly from the web retractor 100 in the direction F at a relatively high rate (e.g., a rate of acceleration exceeding 1.5 g (i.e., exceeding 48.25 ft/s²) and corresponding to the forward movement of the seat belt wearer's body in response to a crash or other potentially injurious dynamic event), thereby causing the retractor 100 to move from the unlocked configuration described above with reference to FIGS. 4B and 4C, and into the locked configuration illustrated in FIGS. 4D and 4E. More specifically, when the seat belt web 122 is extracted from the retractor 100 at or above such a rate, it drives the spool shaft 322, and in turn the pawl arm 346, in the counterclockwise direction CCW at a correspondingly high rate of rotation. Normally, rotation of the pawl arm 346 in the counterclockwise direction CCW would also drive the locking pawl 344 and the inertia disk 342 in the counterclockwise direction CCW. However, when the web 122 is extracted from the retractor 100 at a high rate, the rotational inertia of the counterweights portions 353a, 353b (FIG. 3A) resists the rotational acceleration, and as a result, the tension spring 350 elongates and the bearing surface 355 on the locking pawl 344 (FIG. 3C) bears against the opposing surface of the recess 345 in the inertia disk 342 (FIG. 3A), thereby driving the locking pawl 344 radially outward from the spool shaft 322. The outward movement of the locking pawl 344 causes the engagement surface 349 on the locking pawl 344 to engage one of the teeth 337 on the inner diameter of the locking gear 338. This locks the spool shaft 322 to the locking gear 338, which in turn rotates the locking gear 338 in the counter-clockwise direction CCW and drives the gear rack 478 forward in the direction F, thereby compressing the compression spring 477 against the second end portion 461b of the elongate recess 460 (FIG. 4A). As those of ordinary skill in the art will understand, the tension in the spring 350 can be tailored so that the inertial locking mechanism 320 engages the locking gear 338 and hence the gear rack 478 at virtually any selected rotational speed of the spool shaft 322.

As the gear rack 478 moves in the direction F, the driven gear 476 rotates in the counter-clockwise direction CCW, thereby rotating the shaft 462 in the counter-clockwise direction CCW by virtue of engagement of the driven gear 476 with the shaft 462. The driving member 471, which is fixedly attached to the shaft 462, is also rotated in the counter-clockwise direction CCW, thereby driving the bearing surface 473 of the driving member 471 generally upward against the bearing surface 487 of the second clamping member 482b. Because the bearing surface 487 is inclined toward the rotational axis 469 of the driving member 471 in the upward direction, the upward movement of the bearing surface 473 against the bearing surface 487 drives the second clamping member 482b forward in direction F. More specifically, in the illustrated embodiment the radial distance of the bearing surface 487 from the rotational axis 469 of the driving member 471 decreases toward the upper edge of the bearing surface 487. As a result, upward movement of the bearing surface 473 against the bearing surface 487 pushes the second clamping member 482b forward in direction F to provide clearance for rotation of the driving member 471. Because the first and second clamping members 482a, 482b can only move vertically relative to each other by virtue of the sliding engagement of the protrusions 484a, 484b and the recessed portions 486a, 486b (FIG. 4A), which constrain lateral movement of the first and second clamping members 482a, 482b relative to one another, the first and second clamping members 482a, 482b move together in direction F when the driven member 471 drives the second clamping member 482b forward. As the first and second clamping members 482a, 482b slide forward in direction F on the lower and upper walls 495a, 495b of the cavity 492, respectively, the angle between the walls drive the first and second clamping members 482a, 482b toward each other, thereby clamping the seat belt web 122 between the first and second clamping surfaces 488a, 488b. Additionally, continued tension on web 122 tends to pull the clamping members 482a, 482b in direction F and further drive the clamping members 482a, 482b toward each other due to the friction between the web 122 and the clamping surfaces 488a, 488b. As a result, the clamping members 482a, 482b firmly grasp the web 122 therebetween and prevent further movement of the web 122 from the retractor 100.

In some embodiments, only one of the clamping members 482a, 482b may be movable relative to the clamp housing 490 to clamp the web 122 between the first and second clamping surfaces 488a, 488b. For example, in such embodiments the protrusions 484a, 484b can be omitted such that the second clamping member 482b is not constrained relative to the first clamping member 482a. Additionally, the first clamping member 482a can be coupled to the clamp housing 490 (e.g., via fasteners, adhesives, welding, etc.) or, in other embodiments the first clamping member 482a can be integrally formed with the clamp housing 490. Thus, when the head portion 474 pushes on the bearing surface 487 of the second clamping member 482b, the second clamping member 482b can slide along the upper wall 495b of the clamp housing 490 and move toward the first clamping member 482a to clamp the web 122 between the first and second clamping surfaces 488a, 488b.

As explained above, use of the web retractor 100 can significantly reduce undesirable web pay out because the web locking mechanism 470 clamps the web 122 near the web aperture 212 from the retractor 100, thereby removing the portion of the web wound onto the spool shaft 322 from the equation and preventing the payout of additional web caused by film spooling or web elongation. Accordingly, web retractors configured in accordance with the present technology can be advantageously used with relatively long seat belt webs without excessive passenger excursion from web film spooling or elongation under load.

When the tension on the seat belt web 122 is released, the torsion spring 324 (FIG. 3A) drives the spool shaft 322 in the clockwise direction CW, thereby pulling the seat belt web 122 toward the web retractor 100. Additionally, rotation of the spool shaft 322 in the clockwise direction CW also drives the pawl arm 346 in the clockwise direction CW, which in turn causes the locking pawl 344 to retract inwardly under the biasing force of the tension spring 350. This inward movement of the locking pawl 344 disengages the locking pawl 344 from the inner teeth 337 on the locking gear 338. Disengaging the locking pawl 344 from the locking gear 338 enables the compression spring 477 to translate or drive the gear rack 478 rearwardly in the direction R, which in turn drives the driven gear 476 in the clockwise direction CW. Rotation of the driven gear 476 in the clockwise direction CW rotates the driven member 471 in the clockwise direction CW, which in turn causes the bearing surface 473 on the distal edge of the head portion 474 to move downwardly on the bearing surface 487 of the second clamping member 482b toward the position shown in FIG. 4C. As the bearing surface 473 moves downwardly, the biasing members 480a, 480b bias the first and second clamping members 482a, 482b away from each other, causing the first and second clamping members 482a, 482b to slide aft in direction R on the lower and upper walls 495a, 495b, respectively, due to the tapered shape of the cavity 492. As a result, relieving the tension in the seat belt web 122 simultaneously unlocks the web retractor 100 and positions the first and second clamping members 482a, 482b in the position shown in FIGS. 4B and 4C, thereby enabling the web 122 to continue winding onto the spool shaft 322 until fully retracted.

It should be noted that the inertial locking mechanism 320 described in detail above is but one example of a suitable web shaft inertial locking mechanism that can be used with embodiments of the present technology. In other embodiments, other types of inertial locking mechanisms using, for example, other types of counterweights can be used to lock the spool shaft 322 to the locking gear 338 in accordance with the present technology. Accordingly, those of ordinary skill in the art will understand that the present technology is not limited to use with any particular inertial locking mechanism, but instead can be used with other types of inertial or other locking systems that enable the spool shaft 322 to engage the locking gear 338 and translate or drive the gear rack 478 when the web 122 is extracted from the retractor 100 at or above a preset speed and/or acceleration.

In some embodiments, the web retractor 100 can include an additional locking feature that can be manually actuated to engage the teeth on the ring gear 340 (FIG. 3A) to lock the inertia disk 342 in a stationary position. Locking the inertia disk 342 in this manner would in turn would cause the locking pawl 344 to automatically engage the locking gear 338 after only a very small rotation of the spool shaft 322 in the counter-clockwise direction CCW and regardless of the rate at which the web is withdrawn from the retractor 100. This in turn would cause the web retractor 100 to automatically lock as described above when any tension was applied to the seat belt web 122. In some embodiments, such manual locking features can include, for example, a cable operated pushrod that can be manually operated to engage the rod tip with the teeth on the ring gear 340. It is contemplated that other types of manual locking features can be included with some embodiments of the present technology.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference in the entirety, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A seat belt web retractor, comprising:
a spool shaft configured to receive a seat belt web; and
a web locking mechanism operably coupled to the spool shaft, wherein the web locking mechanism includes a first clamping member and a second clamping member, and
wherein at least one of the first clamping member or the second clamping member is configured to move toward the other of the first clamping member or the second clamping member, clamping the seat belt web therebetween, in response to rotational acceleration of the spool shaft at or above a preset rate caused by extraction of the seat belt web from the seat belt web retractor.

2. The seat belt web retractor of claim 1 wherein—
the web locking mechanism further includes a clamp housing having a lower wall and an upper wall defining a cavity therebetween,
the lower wall is positioned at a non-zero angle relative to the upper wall,
the first clamping member includes a first sliding surface positioned against the lower wall,
the second clamping member includes a second sliding surface positioned against the upper wall, and
the first sliding surface is configured to slide against the lower wall and the second sliding surface is configured to slide against the upper wall in response to the rotational acceleration of the spool shaft at or above the preset rate.

3. The seat belt web retractor of claim 2 wherein—
the first clamping member further includes a first clamping surface opposite the first sliding surface, the first clamping surface configured to press against a first side of the seat belt web,
the second clamping member further includes a second clamping surface opposite the second sliding surface, the second clamping surface configured to press against a second side of the seat belt web opposite the first side, and
at least one of (i) the first sliding surface is positioned at a non-zero angle relative to the first clamping surface or (ii) the second sliding surface is positioned at a non-zero angle relative to the second clamping surface.

4. The seat belt web retractor of claim 2 wherein the non-zero angle between the lower wall and the upper wall of the clamp housing is between 5 degrees and 20 degrees.

5. The seat belt web retractor of claim 1 wherein the web locking mechanism further includes a driving member, and wherein the driving member is configured to drive the at least one of the first clamping member or the second clamping member toward the other of the first clamping member or the second clamping member in response to the rotational acceleration of the spool shaft at or above the preset rate.

6. The seat belt web retractor of claim 5 wherein the driving member includes a collar portion configured to receive a shaft and a cam portion extending outwardly from the collar portion, and wherein the driving member is configured to rotate about the shaft causing the cam portion to push against the at least one of the first clamping member or the second clamping member in response to the rotational acceleration of the spool shaft at or above the preset rate.

7. The seat belt web retractor of claim 1, wherein the web locking mechanism further includes a biasing member positioned to bias the first and second clamping members away from each other to define a space therebetween for passage therethrough of the seat belt web.

8. The seat belt web retractor of claim 1, wherein the first clamping member includes a first clamping surface configured to press against a first side of the seat belt web and the second clamping member includes a second clamping surface configured to press against a second side of the seat belt web opposite the first side of the seat belt web, and wherein at least one of the first or second clamping surfaces includes a plurality of teeth configured to grip the seat belt web.

9. The seat belt web retractor of claim 1 wherein the first clamping member includes a protrusion, wherein the second clamping member includes a recess configured to slidably receive the protrusion to constrain lateral movement of the first and second clamping members relative to each other as the at least one of the first clamping member or the second clamping member moves toward the other of the first clamping member or the second clamping member.

10. The seat belt web retractor of claim 1, further comprising:
an inertial locking mechanism operably coupled to the spool shaft and including a locking gear,
wherein the web locking mechanism further includes:
a driving member;
a driven gear coupled to the driving member; and
a gear rack positioned to engage the locking gear and the driven gear,
wherein the locking gear is configured to rotate in response to the rotational acceleration of the spool shaft at or above the preset rate, thereby rotating the driven gear via the gear rack and causing the driving member to push against the at least one of the first clamping member or the second clamping member.

11. The seat belt web retractor of claim 10 wherein the gear rack is configured to translate in a first direction in response to the rotational acceleration of the spool shaft at or above the preset rate, and wherein the web locking mechanism further includes a biasing member positioned to bias the gear rack in a second direction, opposite the first direction.

12. A seat belt web retractor, comprising:
a spool shaft;
a web wound about the spool shaft; and
a web locking mechanism spaced apart from the spool shaft, the web locking mechanism including a first clamping member and a second clamping member, wherein the first clamping member is configured to translate toward the second clamping member to clamp the web therebetween in response to the web being withdrawn from the spool shaft at or above a preset rate of acceleration.

13. The seat belt web retractor of claim 12 wherein the web locking mechanism further includes a clamp housing having a tapered cavity configured to slidably receive at least the first clamping member.

14. The seat belt web retractor of claim 13 wherein the web locking mechanism further includes a driving member configured to contact and push the first clamping member into the tapered cavity and thereby toward the second clamping member in response to the web being withdrawn from the spool shaft at or above the preset rate of acceleration.

15. The seat belt web retractor of claim 12, further comprising an inertial locking mechanism including a locking gear, wherein the web locking mechanism further includes a cam, wherein the locking gear is configured to rotate in response to the web being withdrawn from the spool shaft at or above the preset rate of acceleration, and wherein rotation of the locking gear is configured to rotate the cam against the first clamping member and drive the first clamping member toward the second clamping member.

16. The seat belt web retractor of claim 12 wherein the first and second clamping members are configured to prevent payout of a portion of the seat belt web extending between (i) the spool shaft and (ii) the first and second clamping members clamping the web.

17. The seat belt web retractor of claim 12 wherein the second clamping member is configured to translate toward the first clamping member to clamp the web therebetween in response to the web being withdrawn from the spool shaft at or above the preset rate of acceleration.

18. A method of operating a seat belt web retractor, the method comprising:
in response to extraction of the seat belt web from the web retractor at or above the preset rate of acceleration, rotating a locking gear of an inertial locking mechanism; and
in response to rotating the locking gear, moving at least one of a first clamping member or a second clamping member toward the other of the first clamping member or the second clamping member, thereby clamping the seat belt web therebetween.

19. The method of claim 18, further comprising:
in response to rotating the locking gear, rotating a driving member against the first clamping member to move the first clamping member toward the second clamping member.

20. The method of claim 18 wherein moving the at least one of the first clamping member or the second clamping member comprises:
moving the first and second clamping members into a tapered cavity defined by lower and upper walls; and
sliding the first and second clamping members against the lower and upper walls, respectively.

21. The method of claim 18 wherein rotating the locking gear in response to the extraction of the seat belt web from the web retractor includes rotating the locking gear in a first direction, and wherein the method further comprises:
in response to release of tension in the seat belt web, rotating the locking gear in a second direction, opposite the first direction; and
in response to rotating the locking gear in the second direction, moving the at least one of the first clamping member or the second clamping member away from the other of the first clamping member or the second clamping member, thereby releasing the seat belt web therebetween.
